(19) United States
(12) Patent Application Publication
(10) Pub. No.: US 2026/0204507 A1
(43) Pub. Date: Jul. 16, 2026

(54) X-RAY ROTATING ANODE WITH TWO DIFFERENT GRAIN STRUCTURES IN THE FOCAL TRACK COATING

(71) Applicant: PLANSEE SE, Reutte (AT)

(72) Inventors: Jürgen SCHATTE, Reutte (AT); Gebhard ZOBL, Reutte (AT); Maximilian SILLER, Reutte (AT); Thomas SCHWARZ, Reutte (AT)

(21) Appl. No.: 19/138,183

(22) PCT Filed: Nov. 16, 2023
(86) PCT No.: PCT/EP2023/082009

§ 371 Date: Jun. 12, 2025

(30) Foreign Application Priority Data
Dec. 13, 2022 (EP) 22213286.2

(51) Int. Cl. H01J 35/10; H01J 9/18

(52) U.S. Cl. CPC H01J 35/108; H01J 9/18; H01J 2209/012; H01J 2235/081; H01J 2235/085; H01J 2235/088

(57) ABSTRACT

An X-ray rotating anode for generating X-rays has a carrier body and at least one annular focal track coating extending along a focal track on the carrier body. The carrier body is made of Mo or a Mo-based alloy and the at least one annular focal track coating is made of W or a W-based alloy. The focal track coating has a first layer and a second layer lying directly above the first layer in a perpendicular direction to the focal track surface starting from the carrier body. The first layer has a grain structure that differs from the second layer.

The present invention relates to a rotary X-ray anode having at least one annular focal track coating extending along a focal track surface, wherein the focal track coating, starting from the carrier body in a direction perpendicular to the focal track surface, has a first layer and a second layer lying directly above the latter, the first layer having a grain structure different from the second layer.

Rotary X-ray anodes are used in X-ray tubes to generate X-rays. In operation, electrons are emitted from a cathode of the X-ray tube and are accelerated in the form of a focused electron beam onto the rotary X-ray anode set in rotation. The rotational movement of the rotary X-ray anode causes the electron beam to scan an annular path—the focal track. In the region of the focal track, rotary X-ray anodes have a focal track coating, which is formed on a carrier body. A rotary X-ray anode rotates at high speed under the focused electron beam. The global voltage state of a rotary X-ray anode is obtained when the power density in the focal spot is evenly distributed over the entire surface area scanned. Each time a certain surface element on the focal track is hit directly by the electron beam (for high-performance anodes, e.g. typically for a period of 10 μsec (1 μsec=1*10⁻⁶ seconds)), the voltage state changes locally in this surface element compared to the global voltage state of the rotary X-ray anode. Where the focal track is hit directly by the electron beam (i.e. in the focal spot), there is typically also a change in tensile and compressive stresses (when entering the electron beam and exiting the electron beam), specifically each time the surface element on the focal track moves through under the electron beam. Compressive stresses arise when the surface element expands in relation to the comparatively colder environment. Tensile stresses occur due to the plastic deformation at high temperatures and due to the contraction of the previously strongly heated surface element that occurs during the subsequent cooling. As use the rotary X-ray anode progresses, the focal track coating will age, i.e. fatigue cracks and thermal shock cracks may occur in the focal track coating. In the course of the use of the rotary X-ray anode, the focal track also ages due to local melting and particle detachment. With increasing roughening or roughness of the focal track surface, more energy is absorbed from the impacting electrode beam over the focal track surface, as the proportion of backscattered electrons decreases. This further increases the effect of ageing.

Typically, rotary X-ray anodes are produced as a composite by powder metallurgy, i.e. the carrier body and the focal track coating are pressed together as a composite, sintered, and typically shaped by forging with a lower degree of deformation compared to semi-finished products (in the case of semi-finished products, the degree of deformation is typically in the range of 60 to 90%). In normal cases, the rotary X-ray anode is then annealed in a recrystallizing manner. An almost uniform grain structure then forms both in the carrier body and in the focal track coating.

As has already been described above, fatigue cracks and thermal shock cracks form during use of the rotary X-ray anode and propagate along grain boundaries at the surface of the focal track coating. With a uniform grain structure, individual grains or particles can already be infiltrated by these cracks on the surface of the focal track coating, which means that they are thermally insulated and thus “overheat”, i.e. the individual grains form melts or can detach from the surface.

The surface of the focal track coating thus becomes rougher. In the course of its use, the focal track ages due to progressive crack growth and increased energy absorption from the electron beam, which consequently results in melting, detachment of grains (particles) and increased roughness. As a result, the service life of rotary X-ray anodes is limited.

Both the formation of cracks in the focal track coating and the additional damage to the surface of the focal coating have disadvantageous consequences for the yield of the X-ray dose and thus have a negative effect on the image quality of the X-ray images. If a critical threshold value for the X-ray dose yield is not reached, either the entire rotary X-ray anode has to be replaced or at least the damaged focal coating has to be reworked or renewed. There is therefore a need for rotary X-ray anodes having a long service life or a long period of use.

AT 12 494 U1 discloses a rotary X-ray anode having a carrier body and a focal track, wherein the carrier body and the focal track are produced as a composite by powder metallurgy. The aim is thus to provide a rotary X-ray anode which enables a high dose yield over long periods of use and which has a long service life. At least one portion of the focal track is present in a non-recrystallized and/or in a partially recrystallized structure. This leads to the abovementioned uniform grain structure in the focal track coating and to the disadvantages already mentioned.

The utility model AT 001 984 U1 discloses a method for producing an anode for X-ray tubes. In this method, the focal track coating is applied to an already formed base body by inductive plasma spraying. As a result, the focal track coating forms a predominantly columnar structure. In said application, the total thickness of the focal track coating is between 0.4 and 0.7 mm (this generally requires 20-50 times superposition of the individual layers of the spray coating). This can reduce the infiltration of the grain boundaries, which can have a positive effect on the ageing of the anode. However, this structure has the effect that the crack growth can spread practically unrestricted (along the grain boundaries) into the focal track in the direction of the base material. In some cases, it can even lead to cracks all the way into the base material. Such deep cracks limit the service life of a rotary X-ray anode.

EP 0 756 308 B1 discloses an X-ray tube that withstands long-term and continuous use. For this purpose, a covering made of an X-ray-generating metal (focal track) is applied to a base material by means of chemical vapour deposition (CVD). In this case, the focal track coating provided by means of CVD should have a maximum average crystal grain diameter of 30 μm, preferably a maximum of 10 μm. According to said patent, a small crystal grain diameter has the effect of suppressing the roughening of the focal track surface. The thickness of the focal track should not exceed 100 μm. Here too, a columnar crystal structure forms. The disadvantages of such structures have already been explained above.

WO 2016/179615 discloses an X-ray anode having a first and a second emission layer on a carrier body. However, both emission layers are separated by an intermediate layer. After a first focal track has been used up (and after removal of the intermediate layer), a second, new focal track can be made available. However, this X-ray anode does not delay the ageing of the respective focal track.

The object of the present invention is to effectively delay the ageing of the focal track of a rotary X-ray anode and thus extend the service life of the rotary X-ray anode. In particular, fatigue cracks and thermal shock cracks are to be guided as directly as possible away from the focal track surface, and the occurrence of thermally insulated grains on the focal track surface is to be prevented. To avoid the cracks running unrestricted into the base material, the progress of the cracks in the direction of the base material is also to be stopped. Furthermore, the object of the present invention is to provide a method for producing such a rotary X-ray anode.

The object is achieved by a rotary X-ray anode according to Claim 1 and by a method according to Claim 10 for producing a rotary X-ray anode. Advantageous embodiments of the invention are set forth in the dependent claims. Features and details that are described in association with the rotary X-ray anode according to the invention are of course also applicable in association with the method according to the invention, and vice versa in each case, such that mutual reference is or may always be made to the individual aspects of the invention with regard to the disclosure.

According to the present invention, a rotary X-ray anode for generating X-rays is provided, which comprises a carrier body and at least one annular focal track coating extending along a focal track on the carrier body, the carrier body being made of Mo or an Mo-based alloy, and the at least one annular focal track coating being made of W or a W-based alloy, characterized in that the focal track coating, starting from the carrier body in a direction perpendicular to the focal track surface, has a first layer and a second layer lying directly above the latter, the first layer having a grain structure different from the second layer.

The inventors have found that, in the rotary X-ray anode according to the invention, the crack formation and the crack propagation are specifically influenced by deliberate adjustment of two different grain structures in the focal track coating. In addition, the melting of grains and also the infiltration of grains on the focal track surface is significantly reduced.

In particular, these effects can be achieved when the first layer of the focal track coating has a globular grain structure and the second layer preferably has a columnar grain structure. A directed (columnar) grain structure of the focal track coating (second layer) lying on the surface reduces the infiltration of grain boundaries, which has a positive effect on ageing. Fatigue cracks and thermal shock cracks are guided as directly as possible into the depth through this directed grain structure, where they meet a different (globular) grain structure (first layer), by which the cracks coming from the focal track surface are deflected from the vertical direction and the progression of the cracks is thus slowed down. This can effectively delay the ageing of the focal track and also extend the service life of the rotary X-ray anode by limiting the crack depths. The cracks guided directly into the depth from the surface effectively reduce the tensile and compressive stresses in the focal track surface when applying the electron beam load and switching off the electron beam load, which results in significantly reduced ageing in the direct vicinity of the cracks.

With regard to thermal expansion, the carrier body of the rotary X-ray anode consists of molybdenum or a molybdenum-based alloy (such as TZM and MHC in particular). These materials have proven themselves particularly suitable in respect of high thermal and mechanical loads. Here, the term “consists” does not rule out that the carrier body can also have additional add-ons or further coating, which for example cover a part of the surface and are are made of another material. Preferably, however, the carrier body consists of molybdenum or a molybdenum-based alloy. A molybdenum-based alloy refers in particular to an alloy which has molybdenum as the main component, i.e. in a higher proportion (measured in percent by weight) than any of the other elements contained, i.e. contains at least 50% by weight of molybdenum. In particular, the molybdenum-based alloy can contain at least 80% by weight of molybdenum, preferably at least 90% by weight of molybdenum, particularly preferably at least 98% by weight of molybdenum.

On the carrier body, in the region of the focal track, at least one circumferential or annular focal track coating is provided extending along a focal track surface. As has already been mentioned above, further layers, for example an emissivity layer, or add-ons, etc., such as a graphite body, etc., can be provided on the carrier body, in particular on the side facing away from the focal track.

In the present context, the focal track designates the surface portion of the rotary X-ray anode which is intended for scanning with an electron beam (and via which the electron beam is accordingly guided during the use of the rotary X-ray anode). The focal track can accordingly form one or more surface portions of a generally annular focal track coating.

In particular, in the region of the focal track, the carrier body has an angled focal track surface, which preferably forms a circumferential frustoconical outer face. the focal track surface is angled relative to a reference plane extending at right angles to the axis of rotation, which allows the generated X-radiation to exit through a lateral exit window in the respective X-ray device. For example, the focal track surface forms a focal track angle in the range of 2°-16.25°, especially of 7°-13°, relative to this reference surface. In a further embodiment, two focal track subsidiary surfaces with two different angles can form the focal track surface.

According to a preferred embodiment, TZM is used as material for the carrier body. The molybdenum alloy TZM has a titanium content of 0.40 to 0.55% by weight, a zirconium content of 0.06 to 0.12% by weight, a carbon content of 0.005 to 0.04% by weight, an oxygen content of less than 0.03% by weight, and the remaining proportion (apart from any impurities) molybdenum. In another preferred embodiment, MHC is used as material for the carrier body. MHC is understood in this connection to mean a molybdenum alloy that has a hafnium content of 1.0 to 1.3% by weight, a carbon content of 0.05 to 0.12% by weight, an oxygen content of less than 0.06% by weight, and the remaining content (apart from impurities) molybdenum. Both alloys (TZM, MHC) have high strength and hardness. Their mechanical properties are largely preserved at high temperatures, which also permits higher operating temperatures of the rotary X-ray anode.

According to the present invention, the focal track material in the region of the focal track consists of tungsten or a tungsten-based alloy. Here, the term “consists” does not in principle rule out that, for example, the focal track material can also consist of two (or more) different tungsten-based alloys. In particular, at least one focal track coating formed on a carrier body is made from said materials. A tungsten-based alloy refers in particular to an alloy which has tungsten as the main component, i.e. in a higher proportion (measured in percent by weight) than any of the other elements contained, i.e. contains at least 50% by weight of tungsten. In particular, the tungsten-based alloy can contain at least 70% by weight of tungsten, preferably at least 85% by weight of tungsten, particularly preferably at least 90% by weight of tungsten.

In a preferred embodiment, the focal track coating is formed of a tungsten (W)-rhenium (Re) alloy that can have a rhenium content of up to 15% by weight. In particular, the rhenium content is in a range of 5-10% by weight. The materials mentioned are advantageous in terms of the high thermal loads and in terms of the highest possible X-ray dose. The composition of the first layer of the focal track coating and of the second layer of the focal track coating may be identical. However, it is also possible that the composition of the first layer of the focal track coating differs from the composition of the second layer of the focal track coating, although in both cases it is a tungsten or tungsten-based alloy. In one embodiment, the focal track can thus be made of a first layer with a W—Re alloy having 10% by weight of Re and a second layer of W-Re having 5% by weight of Re. This embodiment offers the advantage that the first layer (which was preferably produced by powder metallurgy) provides a better crack resistance at medium temperatures (for example 500 to 1000° C.) and the second layer, which was preferably applied by plasma spraying, generates less rhenium vapour pressure at the same operating temperatures during use of the rotary X-ray anode. Rhenium has a higher vapour pressure than tungsten. The lower the content of Re, the lower the vapour pressure of the alloy. At high vapour pressure, the local heating adversely affects the vacuum in the tube, which can lead, for example, to voltage instabilities such as arcs.

The focal track coating (also referred to as the emission layer), which extends along a focal track surface, is characterized in that it has a first layer and a second layer lying directly above the latter, each layer having a different grain structure. The grain structure can be distinguished, for example, by grain sizes, grain size distribution, grain aspect ratio, degree of recrystallization, etc. Preferably, the grain structure can be distinguished by the grain size or the grain aspect ratio. In the rotary X-ray anode according to the invention, the focal track coating is defined starting from the carrier body in a direction perpendicular to the focal track surface. In particular, the focal track coating has no intermediate layer (barrier layer) to separate or space the first layer from the second layer. Preferably, for improved heat flow, the carrier body and the first and second layer of the focal track coating are connected to each other by material bonding.

According to a further development, the first layer of the focal track coating has a globular grain structure and the second layer preferably has a columnar grain structure. The first layer is the layer that is directly on the carrier body. According to the invention, a globular grain structure denotes a structure having nearly uniform grains for the most part. In this case, for the most part means that at least 80% of the grains under the microscope have a globular structure; preferably more than 90% of the grains have a globular structure. The examination of these characteristic features is carried out in cross section by light microscopy or electron microscopy. This microstructure or grain structure of the first layer can also be described by the grain aspect ratio, which indicates the ratio of grain length to grain width. For the globular grain structure, an average grain aspect ratio of ≤1 is obtained in a direction perpendicular to the focal track surface, in particular an average grain aspect ratio of (0.5-0.95):1, preferably (0.7-0.9):1. The grain aspect is determined using the line intercept method according to ASTM E112. Such a microstructure can occur, for example, after powder metallurgical production and preferably subsequent forming (for example forging). The forming process can then provide a slight preferred orientation (parallel to the focal track surface) of the grains.

If the first layer is produced by a powder metallurgical process (P/M process), pores can be distributed over the entire cross section of the focal track coating in the microstructure of the first layer. These are visible, for example, as small black dots under light microscopy. The average grain size of the first layer is typically between 10 and 75 μm, especially in the range of 20-70 μm, preferably between 20-45 μm (from microscopic micrographs according to ASTM E112). In a further embodiment, this first layer can consist of different W alloys.

Preferably, the first layer of the focal track coating is produced in a composite with the carrier body by powder metallurgy. Powder metallurgical production is understood to include the steps of pressing corresponding starting powders to form a press body and sintering the press body. In addition, the production process can have further steps, e.g. mixing and homogenization (e.g. in a ploughshare mixer) of the powders to be pressed, etc. The sintered part is preferably also subjected to further processing steps, such as forming (rolling, forging, etc.), so that it is then present in a formed structure, subsequent annealing (typically recrystallizing), etc.

The second layer of the focal track coating has a predominantly columnar grain structure, wherein the individual grains have a common growth direction, i.e. are oriented almost in the same direction. The columnar grain structure is preferably oriented in a direction almost perpendicular to the focal track surface. The average grain aspect ratio in the direction perpendicular to the focal track surface is more than 1, in particular (1.5-5):1, preferably (1.5-3):1. The average grain sizes are between 5 and 35 μm, preferably between 10 and 15 μm (from microscopic micrographs according to ASTM E112).

Preferably, the second layer of the focal track coating is produced by thermal spraying, in particular plasma spraying, for example vacuum plasma spraying (VPS).

The inventors have found that the rotary X-ray anode according to the invention with two different grain structures in the focal track coating offers the following advantages:

The columnar grain structure, i.e. the second layer, directs this grain structure's fatigue cracks and thermal shock cracks directly into the depth, i.e. away from the surface of the focal track. This reduces the formation of thermally insulated grains on the surface of the focal track. The globular grain structure, i.e. the first layer, can deflect the cracks coming from the surface of the focal track at the grain boundaries, which slows down the progress of the cracks. With increasing distance from the focal track surface, the heat dissipation away from the focal track surface is barely affected. In this way, the service life of the rotary X-ray anode according to the invention can be significantly extended.

In one embodiment of the invention, the different grain structures of the focal track coating are achieved by the fact that the first layer of the focal track coating is produced by powder metallurgy, and preferably the second layer of the focal track coating is produced by plasma spraying, in particular vacuum plasma spraying.

In a preferred embodiment, the second layer of the focal track coating has a layer thickness of at least 250 μm. As has already been described above, each time the surface element moves under the electron beam, additional tensile and compressive stresses occur near the surface of the rotary X-ray anode. For high-performance anodes, these changes, in comparison with the global voltage state of the anode, typically reach up to 200 μm from the focal track surface vertically into the depth and in this region lead, in comparison to the global voltage state of the anode, to higher voltages or to additional cyclical voltage changes in the microsecond (μsec) range.

Due to the grain structure of the second layer (in this layer thickness) and to cracks being guided directly into the depth, the tensile and compressive stresses in the focal track surface (triggered by the electron beam load and discharge) can be effectively reduced, which leads to significantly reduced ageing (or roughening) in the direct vicinity of the cracks. To fully develop the surface-relaxing effect, especially in the volume affected by the sweep of the electron beam, the layer with a columnar grain structure should have a thickness or depth of at least 250 μm. In this depth range, crack deflection plays an increasingly minor role in local overheating and thus in the accelerated ageing of the focal track surface. A straight progression of cracks into the carrier material must be avoided, since otherwise the electron beam could hit the Mo-based alloy and the Mo-based alloy has a much lower melting point than the focal track alloy, which could lead to inadmissible, increased evaporation in the electron beam and thus potentially to voltage flashovers (so-called arcs).

The total thickness of the focal track coating of the rotary X-ray anode according to the invention, i.e. the thickness of the first and second layer, is preferably between 0.5 and 1.3 mm, more preferably between 0.7 and 1.0 mm. This also results in a minimum thickness for the first layer of the focal track coating, which is between 0.25 and 1.05 mm, preferably between 0.45 and 0.75 mm.

In an alternative embodiment, the rotary X-ray anode according to the invention has a plurality of slots/relief slots, which are arranged uniformly about the circumference and pass through the thickness of the carrier body and the thickness of the focal track coating and each extend via a radial portion in the region between the outer circumference (i.e. the slots open into the outer circumference) of the carrier body and the hole in the carrier body (i.e. the slots end radially outside the hole in the carrier body). At the elevated temperatures that occur during use, such slots allow the material of the rotary X-ray anode to expand in the outer region and they thus reduce plastic deformation, as a result of which stresses within the material and thus material fatigue are reduced and material failure is avoided. Such slots can extend exactly radially (the direction terms “radially” and “axially” are with reference to a predetermined axis of rotation of the rotary X-ray anode). Alternatively, however, they can also run slightly obliquely in relation to the radial direction (e.g. with an angle of >0° to 5°). The gradient in relation to the radial direction, the gradient in relation to the axial direction (here again, they may be slightly inclined with respect to the axial direction, e.g. inclined by an angle in the range of 1°-10°) and/or the width of the slots may vary according to a predefined contour. Furthermore, at the end of the slots (i.e. at the radially inner end), there may also be provided end bores, which preferably extend through the thickness of the carrier body and each have a larger diameter than the width of the opening slots, and/or a circumferential groove. Preferably, all of the slots are formed symmetrically to one another with respect to the axis of rotation. The provision of such slots is particularly advantageous when the thickness of the carrier body increases towards the axis of rotation.

The present invention further relates to a method for producing a rotary X-ray anode, in particular for producing a rotary X-ray anode according to the invention, which may be designed according to one or more of the above-described developments and/or variants, wherein the method comprises the following steps:
a) providing a rotary X-ray anode base body having a carrier body made of Mo or an Mo-based alloy and, on the carrier body, at least one annular focal track coating portion extending along the focal track surface and made of W or a W-based alloy, such that the focal track coating portion, starting from the carrier body in a direction perpendicular to the focal track surface of the rotary X-ray anode base body, has a first layer;
b) applying a second layer made of W or a W-based alloy directly to the first layer of the focal track coating portion by a thermal coating process, such that the focal track coating portion, in a direction perpendicular to the focal track surface of the rotary X-ray anode base body, has the first layer and a second layer directly above the latter, the first layer having a grain structure different from the second layer.

The rotary X-ray anode base body has a carrier body and at least one annular focal track coating portion. In this case, the rotary X-ray anode base body can be a newly produced base body, a scrap base body (which, for example, has defects in the focal track coating after production) or an already aged or used base body. In this context, “used” means that the focal track was already in contact with an electron beam. If a newly produced base body is provided, it is preferably produced by powder metallurgy, by pressing and sintering of corresponding starting powders and preferably subsequent forming (e.g. hot forging, cold forging, etc.).

Moreover, rotary X-ray anodes which have already been in use, and in which consequently the surface of the focal track coating has aged, can be reprocessed by the method according to the invention (also referred to as a “rework”; e.g. removal and new application of the focal track or focal track). An aged focal track coating describes the fatigue of the focal track coating as the load/use of the rotary X-ray anode progresses. An aged focal track coating of this kind can be revised or renewed. In this case, the used focal track coating will be removed until a crack-free surface is obtained, i.e. in particular the layer of the focal track coating that is present on the surface. This does not involve removal of the entire focal track coating as far as the carrier body, and therefore a part of the focal track coating (the first layer) is retained. The used focal track coating can also be removed in the form of a spherical cap. The spherical cap is the curved surface of a ball section with which the focal track coating is processed. This in turn saves material, which further increases sustainability.

The advantage of the invention is therefore not only the renewal of the focal track coating, but that the special grain structure of the focal track coating makes the latter more resilient and thus slows the ageing of the rotary X-ray anode.

From ecological, sustainability and cost aspects, it is desirable to provide rotary X-ray anodes that can be further used or conditioned.

In the method according to the invention, the aged/used surface of the focal track coating is removed from a used base body, and then a focal track layer (the second layer), which has a columnar grain structure, is applied by plasma spraying. As a result, used rotary X-ray anodes can be reused and, in addition, the ageing of the conditioned rotary X-ray anodes can be delayed, which saves enormously on resources.

In addition, the method according to the invention can also be used for rotary X-ray anode base bodies which, after production by pressing, sintering and preferably forging and mechanical processing, have damage in the surface of the focal track coating (so-called scrap anodes). For this purpose, the surface of the focal track coating is similarly removed in order to eliminate the damage and then, by plasma spraying, a focal track layer (the second layer) is applied, which has a columnar grain structure.

The second layer of the focal track coating is preferably applied by a thermal spraying process, such as plasma spraying.

Although it is possible to apply the second layer as a single layer by plasma spraying, the focal track coating can also consist of several overlaid spray layers. In one embodiment of the method according to the invention, the second layer is applied in several strata by the thermal coating process or plasma spraying. In this case, one stratum of the plasma layer corresponds to one rotation of the rotary X-ray anode through the plasma beam. The superposition of these first and optionally subsequent strata then leads to a multiple-strata spray layer. Particularly preferably, this spray layer, i.e. the second layer, has a thickness of 250 μm or more.

In one embodiment, the rotary X-ray anode is subjected to heat treatment after application of the second layer. The purpose of this heat treatment is both a further improvement of microstructures by diffusion processes and a degassing of the anode. The temperature of the annealing treatment depends, among other things, on the material from which the base body was produced. As a rule, the heat treatment is carried out at temperatures of 1350° C. or above, preferably above 1600° C., particularly preferably above 1700° C., typically 1 hour or more. In particular, the higher the annealing temperature, the shorter the heat treatment period.

Further advantages and benefits of the invention will become apparent from the description of exemplary embodiments that follows, with reference to the appended figures.

In the Figures:

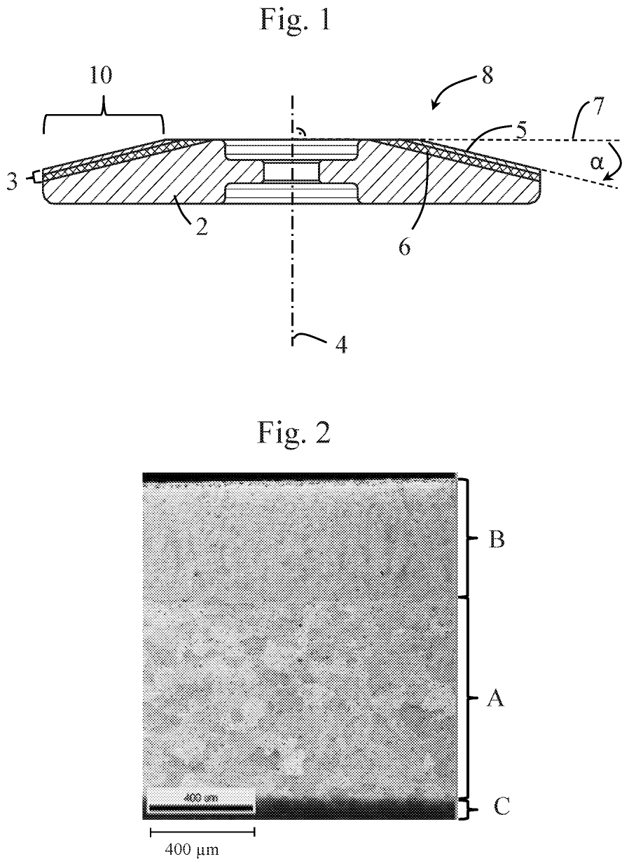

FIG. 1: shows a schematic representation of a rotary X-ray anode according to the invention in cross section;

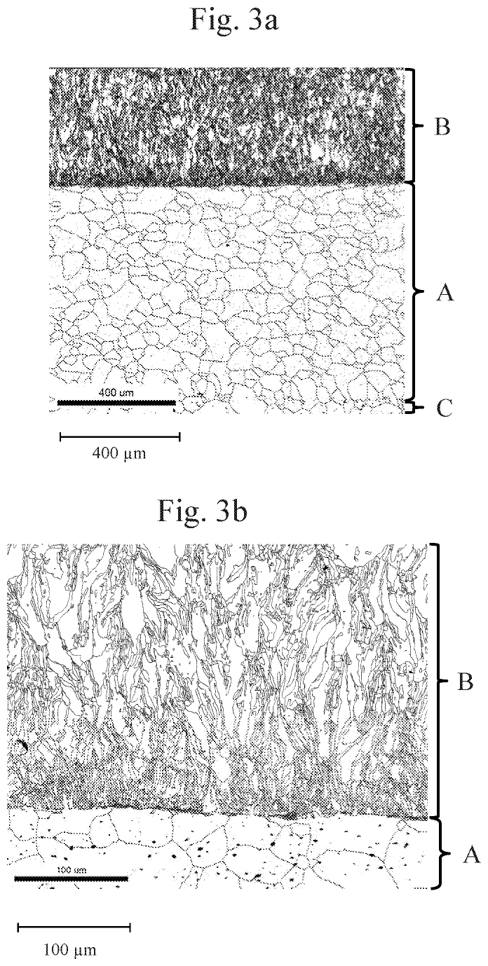

FIG. 2: shows an X-ray electron microscope representation of the focal track on the carrier body in cross section (approximately 50-fold magnification);

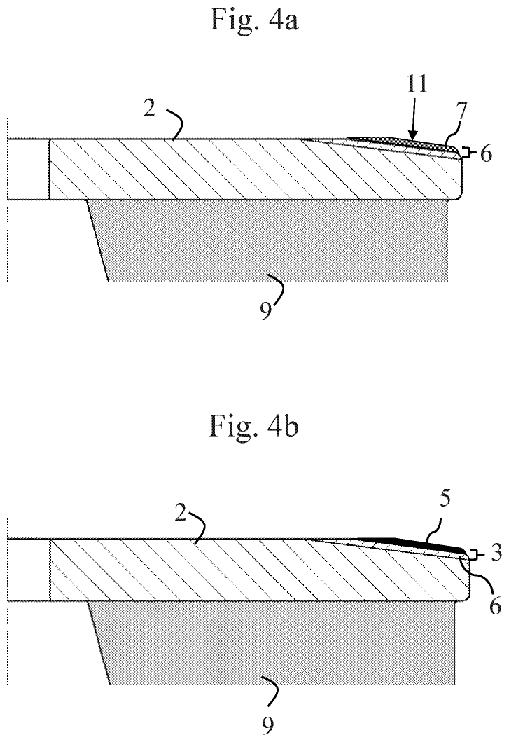

FIG. 3a: shows an X-ray electron microscope representation of the focal track on the carrier body in cross section (approximately 50-fold magnification), by means of a software program, the grain boundaries being easily identifiable;

FIG. 3b: shows FIG. 3a in enhanced resolution, without carrier body (approximately 250-fold magnification);

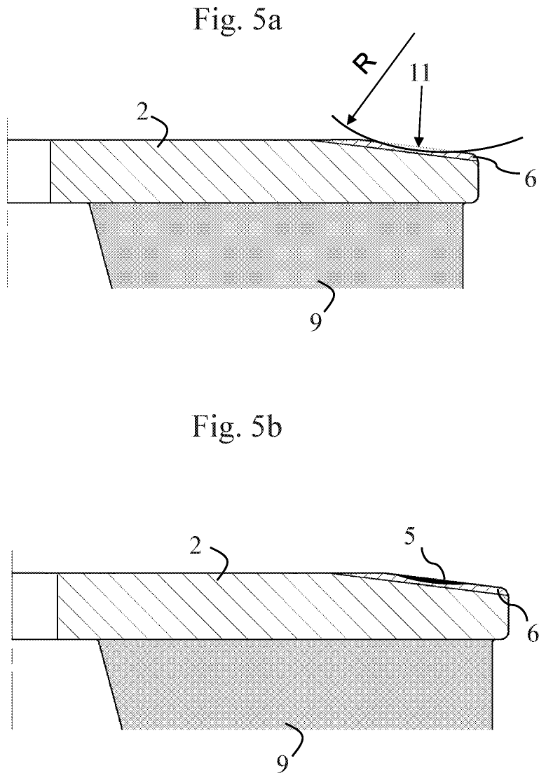

FIG. 4a/4b: shows a schematic representation of a rework sequence on a used rotary X-ray anode in cross section

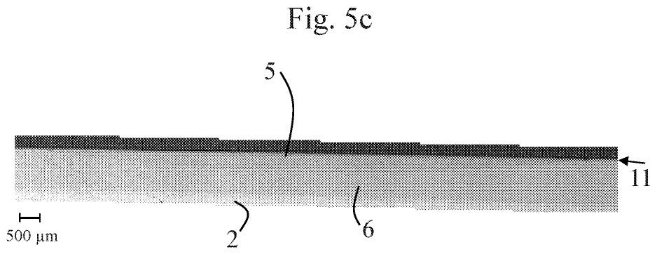

FIG. 5a/5b: shows a schematic representation of a rework sequence on a used rotary X-ray anode in cross section

FIG. 5c: shows a light microscopy image of FIG. 5b (approximately 35-fold magnification).

FIG. 1 shows schematically the structure of a rotary X-ray anode according to the invention in cross section. The rotary X-ray anode 8 is rotationally symmetrical with respect to a rotational symmetry axis 4. The rotary X-ray anode has a disc-shaped or plate-shaped carrier body 2, which can be mounted on a corresponding shaft. On the top side, a focal track coating 3 is applied to the carrier body, which focal track coating has a first layer 6 and a second layer 5 lying directly above the first layer. In the region of the focal track coating, the carrier body 2 has a circumferential bevelled focal track surface 10, which is angled (with an angle α) relative to a reference plane 7 extending perpendicular to the axis of rotation 4. As is known in the field, the outer shape and structure of the rotary X-ray anode 8 may differ from the rotary X-ray anode shown.

FIG. 2 shows an SEM-SE (scanning electron microscope secondary electron contrast) image. FIG. 2 shows, in approximately 50-fold magnification, the carrier body C made of TZM on which the two-layer focal track coating made of W—Re is located. Both layers of the focal track coating are produced from the same W—Re alloy (W: 90% by weight, Re: 10% by weight). The first layer A of the focal track coating was produced by powder metallurgy in combination with the carrier body. The second layer B of the focal track coating is applied by plasma spraying. The globular grain structure of the first layer A and the columnar structure of the second layer B are clearly recognizable.

FIGS. 3a and 3b show an SEM-SE (scanning electron microscope secondary electron contrast) image obtained by EBSD analysis. To this end, the EBSD analysis (electron backscatter diffraction) will be briefly explained. Within the framework of such an EBSD analysis, a characterization of the respective structure can be carried out at a microscopic level. In particular, within the framework of such an EBSD analysis, the respective structure of the layers can be determined, and preferred texturing occurring in the structure can be determined. For this purpose, in the context of the sample preparation, a cross-sectional surface is produced which runs perpendicular to the focal plane (see FIG. 1) through the rotary X-ray anode. The preparation of a corresponding ground surface is carried out in particular by embedding, grinding, polishing and etching at least one portion of the obtained cross-sectional surface of the rotary X-ray anode. Optionally, the face of the ground surface can then be ion-polished (to remove the deformation structure on the surface arising from the grinding operation). The ground surface to be examined is selected so that it has a portion of the focal track and a portion of the carrier body of the rotary X-ray anode, so that both portions can be examined. The measuring arrangement is such that the electron beam hits the prepared ground surface at an angle of 30°. In the case of the scanning electron microscope (here Carl Zeiss “Ultra Plus”), the distance between the electron source (here field emission cathode) and the sample is 22.5 mm, and the distance between the sample and the EBSD camera (here “Hikari XP CCD”) is 16.8 mm. The information given in parentheses relates to the types of devices used by the applicant; in principle, other types of devices that enable the described functions can be used in a corresponding manner. The acceleration voltage is 20 kV, a 50-fold magnification is set and the distance between the individual pixels on the sample, which are scanned consecutively, is 1 μm. For this purpose, use was additionally made of software for the display (here OIM 7.3.1 from EDAX). A grain tolerance angle of 15° is set (which is the usual value for determining grain boundaries with a large angle) to determine the grain boundaries shown. No clean-ups were made in the software. In the software, for the grain illustration, both the Grayscale map type and the Colour coded map type were set to “None”, and for the “Boundaries” a “Rotation angle” of 15 to 180 degrees was defined. The images clearly show the grain boundaries of the focal track coating. The globular grain structure of the first layer A is clearly distinguished from the columnar grain structure of the second layer B. FIG. 3a shows an image with approximately 50-fold magnification, so that a portion of the carrier body C can be identified. FIG. 3b shows the same image at approximately 250-fold magnification. The grain structure of the second layer B is clearly distinguished from the grain structure of the first layer A. In addition, at this magnification, it is possible to see the pores in the first layer A arising from the production by powder metallurgy.

### EXAMPLES

### Example 1

The production of a rotary X-ray anode according to the invention is explained below on the basis of an embodiment of the present invention. First, the starting powders for the carrier body and the starting powders for the focal track coating (first layer) are mixed. The starting powders for the carrier body are chosen in such a way that what is obtained for the carrier body (apart from impurities) is a composition of 0.5% by weight of Ti, 0.08% by weight of zirconium, 0.005-0.04% by weight of carbon, less than 0.03% by weight of oxygen, and the remaining proportion molybdenum (after conclusion of all the processes and heat treatments carried out in the context of the powder metallurgical production) (i.e. TZM). Furthermore, the starting powders are chosen in such a way that what is obtained for the focal track coating (apart from impurities) is a composition of 10% by weight of rhenium and 90% by weight of tungsten. The starting powders are pressed as a composite with 400 tons (corresponds to 4*10⁵ kg) per rotary X-ray anode. The body obtained is then sintered at temperatures in the range of 2,000° C. to 2,300° C. for 2 to 24 hours. The starting body (sintered body) obtained after the sintering has in particular a relative density of approximately 94%. The starting body obtained after the sintering is forged at temperatures in the range of 1300° C. to 1500° C., with the body having a degree of deformation in the range of 20-60% after the forging step. The carrier body is coated, by means of an inductively heated plasma torch having an inner diameter of 50 mm and an output of 65 KW, with spray powder composed of a tungsten alloy with 5% by weight of rhenium content in a powder fraction of between 15 and 63 μm. The spray powder was introduced axially at a delivery rate of 30 g/min using Ar carrier gas. Before the powder injection was started, the carrier body was heated to 1500° C. The speed of rotation of the carrier body was 10 rpm. The plasma gun was moved sideways to the centre line of the focal track coating concentric to the rotary anode axis, specifically in such a way that the axis of the plasma gun has continuously exceeded this centre line alternately on both sides to a maximum of 5 mm at a speed of 2 mm/sec. In a coating process lasting about 3 minutes, a focal track coating with a total thickness of about 250 μm and a width of 25 mm was thus applied by means of approximately 20 individual layers deposited over one another. After completion of the coating process, the rotary anode, cooled to below 100° C., is removed from the vacuum chamber, and then the focal track coating is ground to a thickness of 0.7 mm. Finally, the rotary anode finished in this way was subjected to high-vacuum annealing at a temperature of 1600° C. for 1 hour or longer.

On the rotary X-ray anode according to the invention, the focal track was examined at the end of its service life. It was found that cracks spreading along the columnar grain structure (or columnar grain boundaries) are deflected along the grain boundaries of the globular structure and thus change the direction of propagation several times. Due to this crack deflection along the globular structure, crack propagation deep into the focal track is avoided. At the end of the service life of the focal track, an evenly distributed crack pattern with evenly formed cracks could also be observed on the surface. By contrast, in rotary X-ray anodes used for comparison, in which the focal track was produced only by vacuum plasma spraying, it can be seen that cracks spread along the grain boundaries deep into the focal track unchecked (in some cases down to the carrier body). In addition, the focal track coating of the rotary X-ray anode according to the invention showed no grain outbreaks and a reduced number of melts.

### Example 2

FIGS. 4a and 4b schematically show the reconditioning of an already used (or aged) rotary X-ray anode, in which the focal track coating 6 has clear traces of ageing 7. FIG. 4a shows the focal track coating 6, already having clear traces of use 7 on the surface 11 of the focal track coating, located on the carrier body 2. In addition, the rotary X-ray anode comprises a graphite body 9. The focal track coating 6 is now abraded in such a way that there are no longer any cracks/signs of use, i.e., the coating having clear signs of use 7 is completely abraded. At the end of this process, only part of the focal track coating 6 is still present (see FIG. 4b). In particular, the focal track coating 6 is abraded with a ground plane parallel to the focal track surface to a residual thickness of 0.5-0.7 mm (depending on the initial thickness of the focal track coating and the depth of the traces of use). The resulting ground surface is then electropolished several times, at least twice (in order to remove the deformation structure caused by the grinding process). Thus, a part of the focal track coating 6, which was produced by powder metallurgy, is preserved (i.e. only the coating having the traces of use 7 is renewed). A second layer 5 is then applied by means of inductive plasma spraying, so that a renewed focal track surface is obtained. The total thickness of the focal track coating preferably corresponds to the total thickness of the focal track coating before the first ageing or before the grinding, so that, when the rotary X-ray anode is used after the rework, the location of the formation of the X-rays is identical to that of the rotary X-ray anode that has not yet aged. FIG. 4a shows schematically in cross section the focal track 6 having traces of use 7, and FIG. 4b shows the already renewed focal track coating composed of first layer 6 and second layer 5, resulting in the total focal track coating 3.

### Example 3

FIGS. 5a and 5b schematically show the reconditioning of an already used rotary X-ray anode, in which the focal track coating has clear traces of ageing. FIG. 5a shows the focal track coating 6, already having clear traces of use on the surface 11, located on the carrier body 2. In addition, the rotary X-ray anode comprises a graphite body 9. The focal spot or the focal track, i.e., the point of impact of the electrons on the focal track, of the focal track coating is now abraded with a spherical cap having the radius R, so that cracks/signs of use are no longer present. In particular, the focal track is abraded such that a part of the focal track coating 6 is preserved, i.e. a part of the focal track coating 6 that has been prepared by powder metallurgy is preserved, so that only the used focal track is renewed. A second layer 5 is then applied by means of inductive plasma spraying, so that a planar focal track surface is again obtained. The total thickness of the focal track coating after the rework corresponds to the total thickness of the focal track coating before the grinding, so that, when the rotary X-ray anode is used after the rework, the location of the formation of the X-rays is identical to that of the rotary X-ray anode that has not yet aged (i.e., the rotary X-ray anode before the first ageing). FIG. 5a shows schematically in cross section the focal track 6 having the focal track surface 11 removed by the spherical cap, and, in FIG. 5b, the already renewed focal track 5 with 6 is shown. Preferably, the thickness of the focal track 5, i.e., the second layer, is at least 250 μm at the point of maximum material removal. The point of maximum material removal corresponds to the deepest point in the spherical cap. FIG. 5c shows a light microscopy image of the carrier body 2 with the powder metallurgical first layer 6 and the plasma-sprayed second layer 5. The focal track surface 11 is indicated by the arrow.

1-16. (canceled)

17. A rotary X-ray anode for generating X-rays, the rotary X-ray anode comprising:
a carrier body made of Mo or an Mo-based alloy;
at least one annular focal track coating made of W or a W-based alloy, said focal track coating extending along a focal track surface on said carrier body;
said focal track coating, starting from said carrier body and in a direction perpendicular to the focal track surface, having a first layer and a second layer lying directly above said first layer, and said first layer having a grain structure different from said second layer.

18. The rotary X-ray anode according to claim 17, wherein said first layer of said focal track coating has a globular grain structure and said second layer of said focal track coating has a columnar grain structure.

19. The rotary X-ray anode according to claim 18, wherein the globular grain structure, starting from said carrier body and in a direction perpendicular to the focal track surface, has an average grain aspect ratio of ≤1.

20. The rotary X-ray anode according to claim 18, wherein the columnar grain structure, in a direction perpendicular to the focal track surface, has an average grain aspect ratio of >1.

21. The rotary X-ray anode according to claim 17, wherein said second layer has a layer thickness of at least 250 μm.

22. The rotary X-ray anode according to claim 17, wherein said Mo-based alloy is a titanium-zirconium-molybdenum (TZM) alloy or a molybdenum-hafnium-carbon (MHC) alloy.

23. The rotary X-ray anode according to claim 17, wherein said W-based alloy is a W—Re alloy.

24. The rotary X-ray anode according to claim 17, wherein a composition of said first layer of said focal track coating is different from a composition of said second layer of said focal track coating.

25. The rotary X-ray anode according to claim 17, wherein said first layer of said focal track coating is produced by powder metallurgy, and said second layer of said focal track coating is produced by plasma spraying.

26. A method for producing a rotary X-ray anode, the method comprising the following steps:
a) providing a rotary X-ray anode base body having a carrier body made of Mo or an Mo-based alloy and, on the carrier body, at least one annular focal track coating portion made of W or a W-based alloy and extending along a focal track surface, with the focal track coating portion, starting from the carrier body in a direction perpendicular to the focal track surface of the rotary X-ray anode base body, forming a first layer;
b) applying a second layer made of W or a W-based alloy directly on the first layer of the focal track coating portion by a thermal coating process, to form a focal track coating portion which, in a direction perpendicular to the focal track surface of the rotary X-ray anode base body, has the first layer and the second layer directly above the first layer, with the first layer having a grain structure different from the second layer.

27. The method according to claim 26, wherein the step of providing the rotary X-ray anode base body with the first layer comprises a step of producing the carrier body and the first layer as a composite by powder metallurgy.

28. The method according to claim 26, wherein the step of providing the rotary X-ray anode base body with the first layer comprises:
providing a used rotary X-ray anode base body having a carrier body and a first layer, wherein the carrier body and the first layer are elements having been produced as a composite by powder metallurgy; and
working off a used portion of the first layer.

29. The method according to claim 26, which comprises applying the second layer by plasma spraying.

30. The method according to claim 26, which comprises applying the second layer by plasma spraying in a plurality of layers.

31. The method according to claim 26, which comprises, subsequent to applying the second layer, carrying out a heat treatment of the rotary X-ray anode.

32. The method according to claim 31, which comprises carrying out the heat treatment of the rotary X-ray anode at a temperature of ≥1350° C.
